(19) United States
(12) Patent Application Publication
(10) Pub. No.: US 2009/0110547 A1
(43) Pub. Date: Apr. 30, 2009

(54) Method for producing a contoured gap, and turbo-engine comprising contoured gap

(75) Inventors: Peter Fledersbacher, Stuttgart (DE); Wolfgang Ruff, Stuttgart (DE); Martin Schlegl, Rudersberg (DE); Holger Stark, Allmersbach (DE)

Correspondence Address: Davidson, Davidson & Kappel, LLC, 485 7th Avenue, 14th Floor, New York, NY, 10018, US

(73) Assignee: DaimierChrysler AG, Stuttgart (DE)

(21) Appl. No.: 11/661,477

(22) PCT Filed: Jul. 11, 2005
(86) PCT No.: PCT/EP2005/007476

§ 371 Date: Mar. 19, 2008

(30) Foreign Application Priority Data
Aug. 30, 2004 (DE) 102004042258.3

(51) Int. Cl. F01D 11/12; B23P 15/00

(52) U.S. Cl. 415/173.4; 415/1; 29/888.02

(57) ABSTRACT

A method for producing a contoured gap between a rotor and a stator of a turbo-engine is provided. A first turbo-engine drives a second turbo-engine by means of a common shaft, the shaft being mounted in a bearing housing by means of a bearing. The aim of the invention is to enable the contoured gap to be created in a simple and reliable manner. To this end, the contoured gap is formed between a contoured surface of the rotor and a contoured surface of an engine housing associated with the rotor, by grinding the contoured surfaces against each other, using the axial play of the bearing.

The present invention relates to a method for producing a contoured gap and a turbo-engine having a contoured gap, as recited in the preambles of the independent claims.

The gap dimension of a contoured gap between a rotor designed as an impeller and a corresponding contoured surface on an engine housing is an important measure of the efficiency of a turbo-engine, for example a turbine or compressor. The smaller the settable gap dimension, the higher the efficiency of the turbo-engine. The gap dimension is subject to tolerances. This is attributable primarily to production and assembly tolerances. In the case of an axial clearance of a turbocharger bearing, which is ordinarily present, the gap dimension is variable as a function of operating conditions. There is also the danger of damage to the rotor and engine housing when the two come into contact with each other, in particular in the case of poorly paired materials.

A turbo-engine is known from the patent specification DE 102 21 114 C1, which constitutes a special category, in which a seal made of hollow spheres which are connected to each other at points and may be situated on rotor elements and/or a stator is provided to maintain nearly constant gap dimensions of a contoured gap. Further turbo-engines having a contoured gap are described in DE 103 47 524 A1, U.S. Pat. No. 5,185,217 A, and DE 196 53 217 A1.

The object of the present invention is to provide a simple and cost-effective method for setting a contoured gap of a turbo-engine between a rotor and a stator, the method enabling a defined contoured gap to be reliably set. A further object is to provide a method for setting a contoured gap between a rotor and a stator as well as to provide a turbo-engine.

According to the present invention the object is achieved by the features of the independent claims. Suitable embodiments and advantages of the present invention are provided in the description as well as the further claims.

In the method according to the present invention for producing a contoured gap between a rotor and a stator of a turbo-engine, the contoured gap is formed between a contoured surface of the rotor and a contoured surface of an engine housing assigned thereto as a stator by grinding the contoured surfaces against one another, utilizing an axial clearance of a bearing of a shaft supporting the rotor. This makes it possible to produce very small gap dimensions without complex machining of the contoured surfaces. The tolerance requirements to be met by the components having contoured surfaces corresponding to the rotor are reduced, since grinding may be carried out in the premounted or partially mounted state. The present invention is preferably used for a turbocharger in which a first turbo-engine drives a second turbo-engine via a common shaft, and the shaft is supported by a bearing in a bearing housing.

In the case of a premounted rotor, at least the first turbo-engine, whose engine housing is preferably mounted on the rotor of the first turbo-engine in a first mounting direction axial to the shaft, and the rotor are moved due to the contact between the contoured surface of the rotor and the corresponding contoured surface of the engine housing axially in the mounting direction from a first axial position to a second axial position between the first axial position and an axial limit stop located in the mounting direction. This enables contact over a large surface to be made between the contoured surfaces.

To set a zero gap between the contoured surface of the rotor and the contoured surface of the engine housing, an overpressure is preferably applied to the first turbo-engine until a preset first axial force acts upon the shaft in the mounting direction, and the contoured surfaces are separated by a gap. The rotor is then accelerated by a pressure difference between an inlet and an outlet of the first turbo-engine, and the pressure at the inlet and outlet is evenly reduced until the contoured surface of the rotor grinds against the contoured surface of the engine housing with a preset second axial force, and the rotor decelerates. This enables a zero gap to be reproducibly set under defined conditions, on the basis of which the contoured gap is settable with a high degree of accuracy. The contoured surfaces have a highly accurate, complementary design in this state. Following grinding, the surface may have selectively produced, radially circumferential grooves which may act as a labyrinth seal in combination with the rotor. The contoured surface of the engine housing corresponding to the rotor does not necessarily have to be an integral part of the engine housing, but instead may be a separate component. Inserts, in particular, may be used.

The rotor is preferably accelerated repeatedly and grindingly decelerated until the axial force has dropped to approximately 0 N: The rotor has moved away again from the axial limit stop, in particular moved to an axial zero position.

To set the contoured gap, the pressure at the inlet and outlet of the first turbo-engine is favorably reduced evenly, starting at a particular vacuum, and/or an overpressure is set at the second turbo-engine until a preset axial force acting against the direction of mounting on the shaft is established. The rotor is favorably repeatedly accelerated and grindingly decelerated until the axial force reaches a preset value above the axial force during normal operation. The width of the contoured gap is advantageously determined by the axial force present or the excess force, which is easy to determine and set in a reproducible manner.

The contoured gap for the second turbo-engine driven by the first turbo-engine may be advantageously set in the same manner when the first engine housing of the first turbo-engine is in the mounted state and the rotor of the second turbo-engine is in the premounted state, by mounting the latter's engine housing on the rotor of the second turbo-engine in a second mounting direction opposite the first mounting direction axial to the shaft, and by moving the rotor via the contact between its contoured surface and a corresponding contoured surface of the second engine housing axially in the second mounting direction from a third axial position to a fourth axial position between the third axial position and an axial limit stop located in the second mounting direction. A different axial clearance of the bearing in one or the other direction of movement or direction of mounting may be taken into account by narrowing the tolerance.

To set a zero gap for the second turbo-engine, the rotor is preferably repeatedly accelerated and grindingly decelerated until the axial force has dropped to approximately 0 N and the rotor has moved from the axial limit stop to an axial zero position. The pressure is suitably higher on the side of the second turbo-engine than on the side of the first turbo-engine. A partial vacuum is preferably present on the side of the first turbo-engine to set the zero gap. To set a contoured gap for the second turbo-engine, the rotor is preferably repeatedly accelerated and grindingly decelerated until the axial force has reached a preset value and the rotor has moved from the axial limit stop to an axial operating position.

In the case of a turbo-engine according to the present invention, in particular for a turbocharger such as a secondary air charger and/or an exhaust gas turbocharger for an internal combustion engine of a motor vehicle, having a contoured gap between a contoured surface of a rotor and a contoured surface of an engine housing assigned to the rotor, the contoured gap is settable by grinding the contoured surfaces of the rotor and engine housing, utilizing an axial clearance of the bearing (14), as a result of a defined axial force.

The contoured surfaces preferably have a grindable material pairing. The advantageous material pairing makes it possible to cut costs in the manufacture of turbo-engines. The contoured surface of the rotor is suitably made of a harder material than the contoured surface belonging to the engine housing.

It is advantageous if at least one of the contoured surfaces of the rotor and engine housing have a texture which favors grinding. It is preferable if at least one of the contoured surfaces of the rotor and engine housing is coated. A coating, for example by spraying, having a PTFE layer (PTFE=polytetrafluoroethylene) is favorable. This results in particularly low friction between the coating and the other materials used in turbo-engines, while maintaining good adhesion. Low hardness and high ductility ensure good grinding of the coating, which is additionally improved by adequate porosity and strength. The PTFE coating is also non-corrosive, and there are no abrasive components in the coating.

In addition to selecting a suitable coating material, it is a good idea to set a suitable surface structure, the coating thickness, surface roughness or surface texture and porosity being particularly suitable for influencing the grinding performance. If a suitable material pairing is selected, for example a high-strength plastic for the engine housing and a mixture made of high-strength plastic having a glass fiber component or a light metal alloy for the rotor, a coating does not need to be provided. The grindability of the contoured surfaces on the engine housing may be ensured by the abrasive components (glass fibers) or the higher mechanical characteristic values of light metals compared to plastics. In addition, a special surface texture, for example a corrugated surface such as that of an orange skin, or a sand-blasted or shot-blasted surface, may reduce the resistance of the contoured surface on the engine housing to abrasion by the rotor. Greasing or groove formation in the contoured surface is also facilitated.

The method according to the present invention may preferably be used to create a contoured gap between rapidly rotating impellers and stationary components. Preferred applications include “cold” compressor sides of exhaust gas turbochargers or the compressor side and/or turbine side of secondary air chargers or even electrically or mechanically driven compressors, for example superchargers.

The present invention is explained in greater detail below on the basis of an exemplary embodiment illustrated in the drawing. The drawing, description and claims contain combinations of numerous features which those skilled in the art may also suitably consider individually and combine into additional, practical configurations.

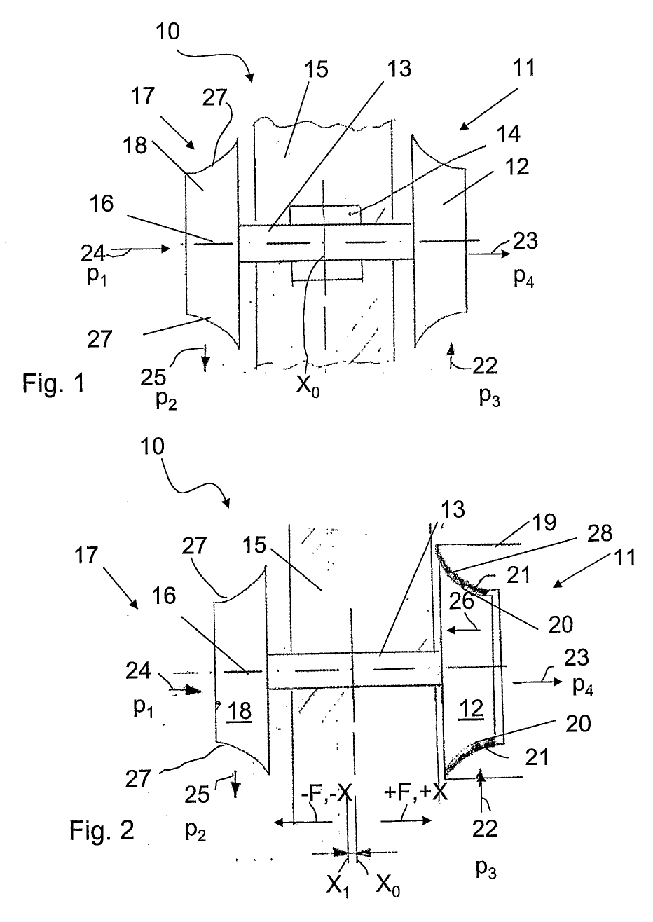

FIG. 1 shows a schematic representation of a preferred secondary air charger including a premounted turbine and a premounted compressor, but excluding any type of engine housing, in the initial state of the method according to the present invention;

FIG. 2 shows the secondary air charger from FIG. 1, including a mounted engine housing;

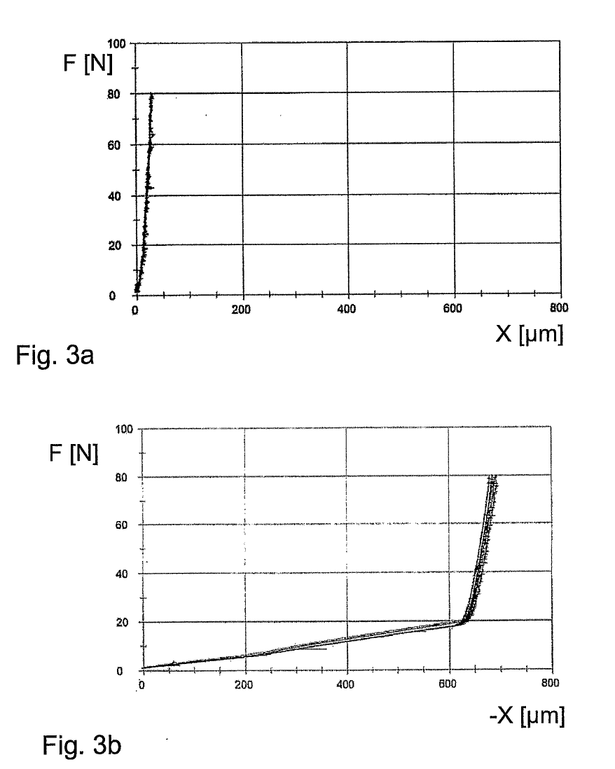

FIGS. 3a, 3b show, by way of examples, an axial clearance of a ball bearing of a preferred secondary air charger upon loading from a compressor side in the direction of a turbine side (a) and in the opposite direction (b).

The following description of the method relates by way of example to the conditioning of secondary air chargers having integrated ball bearings. If necessary pressures and forces are adjusted to a real axial clearance of a bearing of an exhaust gas turbocharger, the method may also be used to condition contoured surfaces on a compressor side of an exhaust gas turbocharger having friction bearings.

Paired ball bearings having an axial clearance of their bearing are used for secondary air chargers. Due to the difference in pressure between the turbine side and compressor side, a force acting in the direction of the turbine side is applied to a ball bearing unit during operation. To counteract this force, and also to reduce the bearing clearance which is practically unavoidable in groove-type ball bearings of this type, the two ball bearings are pretensioned by a spring integrated into the bearing unit. One of the ball bearings is preferably designed as a bivalent fixed bearing having a narrow axial clearance in the positive X direction, i.e., in the direction of the turbine side. The second ball bearing is preferably designed as a monovalent movable bearing and has a large axial clearance in the negative X direction. This type of load does not occur during normal operation of a secondary air charger.

FIG. 3a shows the axial clearance of a ball bearing when loaded in the positive X direction. If even a slight movement occurs in the X direction, axial force F acting upon a shaft increases rapidly in this direction as a result of the narrow axial clearance. FIG. 3b shows the axial clearance of the ball bearing in the negative X direction. In this example, a shaft supported by the bearing is movable up to 600 μm in the negative X direction until a significant increase in the axial force is observed. This corresponds to a limit stop of the bearing in this direction.

To condition the contoured surfaces acting as sealing surfaces on the turbine side, this effect may be used in a particularly advantageous manner according to the present invention.

FIGS. 1 and 2 illustrate the method according to the present invention on the basis of a preferred secondary air charger. Elements which are or remain the same in the figures are identified by the same reference numerals.

A preferred secondary air charger 10 has a first turbo-engine 11 designed as a turbine and having a rotor 12 which drives a second turbo-engine 17 designed as a compressor and having a rotor 18, via a common shaft 13. Shaft 13 is supported in a bearing housing 15 by ball bearing 14, which is preferably designed as described above. Rotor 12 of first turbo-engine 11 has a contoured surface 20, and rotor 18 of second turbo-engine 17 has a contoured surface 27.

Rotors 12, 18 are premounted via ball bearing 13; the engine housings on the turbine and compressor sides, which form stators assigned to rotors 12, 18, are not mounted. Rotors 12, 18 are designed as impellers and are rotatable around rotation axis 16.

First turbo-engine 11 has an inlet 22 at which a pressure p3 is present and an outlet 23 at which a pressure p4 is present. Second turbo-engine 17 has an inlet 24 having a prevailing pressure p1 and an outlet 25 having a prevailing pressure p2. The axial position of the bearing, i.e., the shaft, in the initial position is X0.

FIG. 2 shows the mounting of an engine housing 19 on rotor 12 of first turbo-engine 11 in the latter's mounting direction 26 so that its contoured surface 21 comes into contact with contoured surface 20 of rotor 12. Rotor 12 is thus moved in the direction of second turbo-engine 17, and the bearing moves to a position X1. In the figure, the movement is identified as movement in negative X direction −X. A movement in the opposite direction would represent a movement in positive X direction +X. Axial force F is identified as −F in this direction and as +F in the opposite direction. Contoured surface 21 of engine housing 19 is provided with a coating 28.

Different method steps are characterized below on the basis of their pressures p1, p2, p3, p4 and axial positions with reference to FIG. 2. Positive positions mean a movement in the direction of first turbo-engine 11 (+X) and negative values mean a movement in the direction of second turbo-engine 17 (−X). The values are provided only as examples and may be different for other turbo-engines such as turbochargers of other designs.

Step 1: Initial state

Rotors 12, 18 premounted via ball bearing 13 in bearing housing 15. Engine housing 19 on the turbine side and the engine housing on the compressor side are not mounted.

| p1 [mbar] | p2 [mbar] | p3 [mbar] | p4 [mbar] | Axial position |
|---|---|---|---|---|
| 1,000 | 1,000 | 1,000 | 1,000 | Undefined |

Step 2: “Unpressurized”

Engine housing 19, which has a coating 28 on contoured surface 19, is mounted. Depending on the layer thickness, rotor 12 is moved approximately up to 300 μm in the direction of second turbo-engine 17. This places rotor 12 locally on corresponding contoured surface 21 of engine housing 19.

| p1 [mbar] | p2 [mbar] | p3 [mbar] | p4 [mbar] | Axial position |
|---|---|---|---|---|
| 1,000 | 1,000 | 1,000 | 1,000 | −300 μm |

Step 3: “Position at left stop”

A pressure which is slightly higher than the atmospheric pressure (e.g., +100 mbar) is applied to inlet 22 and outlet 23 of first turbo-engine 11. Due to the pressure increase, rotor 12 is pressed against its left stop in the direction of second turbo-engine 17. This situation does not occur during normal operation. An axial force F of approximately −20 N acts upon shaft 13 (in the direction of second turbo-engine 17). Rotor 12 does not make contact with the surface of engine housing 19. A gap forms between rotor 12 and engine housing 19.

| p1 [mbar] | p2 [mbar] | p3 [mbar] | p4 [mbar] | Axial position |
|---|---|---|---|---|
| 1,000 | 1,000 | 1,100 | 1,100 | −600 μm |

Step 4: “Accelerate rotor assembly”

Pressure p4 at outlet 23 of first turbo-engine 11 is reduced, but remains above the atmospheric pressure. The rotor assembly, which includes rotor 12 and rotor 18, accelerates to the nominal speed as a function of pressure difference Δp(3−4)=p3−p4 between inlet 22 and outlet 23.

| p1 [mbar] | p2 [mbar] | p3 [mbar] | p4 [mbar] | Axial position |
|---|---|---|---|---|
| 1,000 | 1,000 | 1,100 | 1,050 | −600 μm |

Step 5: “Begin grinding”

Pressure p3, p4 at inlet 22 and outlet 23 of first turbo-engine 11 is reduced evenly. An axial force F of approximately −10 N acts upon shaft 13. Shaft 13 is moved by approximately 300 μm to the right in the positive X direction. As a result, rotor 12 begins grinding on engine housing 19. Rotor 12 is decelerated during this process.

| p1 [mbar] | p2 [mbar] | p3 [mbar] | p4 [mbar] | Axial position |
|---|---|---|---|---|
| 1,000 | 1,000 | 1,080 | 1,030 | −300 μm |

Step 6: “Re-accelerate rotor assembly”

Pressure p3, p4 at inlet 22 and outlet 23 of first turbo-engine 11 is increased evenly. Shaft 13 is pressed against the limit stop. Rotor 12 accelerates again to the nominal speed.

| p1 [mbar] | p2 [mbar] | p3 [mbar] | p4 [mbar] | Axial position |
|---|---|---|---|---|
| 1,000 | 1,000 | 1,100 | 1,050 | −600 μm |

Step 7: “Re-grind”

Pressure ratio p3/p4 at inlet 22 and outlet 23 is reduced evenly until axial force F reaches an absolute value of approximately 0 N. A zero gap is set.

| p1 [mbar] | p2 [mbar] | p3 [mbar] | p4 [mbar] | Axial position |
|---|---|---|---|---|
| 1,000 | 1,000 | 1,020 | 980 | 0 μm |

Step 8: “Set contoured gap”

The pressure at inlet 22 and outlet 23 of first turbo-engine 11 is reduced evenly in multiple steps. The axial force acting upon shaft 13 is thereby increased in a multi-step process, e.g., +5 N in the first step and +10 N in the second step, etc. As an alternative to reducing pressure p4 at outlet 23, pressure p1, p2 at inlet 24 and outlet 25 of second turbo-engine 17 may also be increased. Steps 3 through 7 continue to be repeated using an adjusted pressure difference p3−p4 until an axial force F of approximately +100 N is produced in the direction of first turbo-engine 11. This force is approximately 30 N greater than a maximum axial force F occurring during normal operation. Prevailing axial force F, or the force increase over normal operation, determines the width of the contoured gap.

| p1 [mbar] | p2 [mbar] | p3 [mbar] | p4 [mbar] | Axial position |
|---|---|---|---|---|
| 1,000 | 1,000 | 800 | 400 | +50 μm |

The grinding operation on the side of second turbo-engine 17 to set the contoured gap proceeds in the same manner as the grinding operation for first turbo-engine 11. However, it is necessary to take into account the fact that the axial bearing clearance in the direction of first turbo-engine 11 (turbine), which corresponds to the direction of primary loading during operation, is much smaller than it is in the direction of second turbo-engine 17 (compressor), as explained above in reference to FIG. 3. The thickness of the coating on the side of second turbo-engine 17 must therefore be provided within narrower tolerances.

The steps for conditioning contoured surfaces 27 of rotor 18 and the engine housing on the side of second turbo-engine 17 are not illustrated in FIG. 2.

Step 9: “Mount engine housing”

An axial force F of approximately +100 N is set (as in Step 8). Engine housing 19 of first turbo-engine 11 is mounted. The engine housing of second turbo-engine 17 is mounted. Rotor 18, or the rotor assembly including rotor 12 and rotor 18, must be able to rotate.

| p1 [mbar] | p2 [mbar] | p3 [mbar] | p4 [mbar] | Axial position |
|---|---|---|---|---|
| 1,000 | 1,000 | 600 | 600 | +50 μm |

Step 10: “Accelerate rotor assembly”

An axial force F of approximately +100 N is set (as in Steps 8 and 9). Rotor 18 is accelerated by a pressure difference Δp(3−4)=p3−p4. Pressure difference Δp is greater than in normal operation. Rotor 18 reaches its nominal speed.

| p1 [mbar] | p2 [mbar] | p3 [mbar] | p4 [mbar] | Axial position |
|---|---|---|---|---|
| 990 | 1,050 | 650 | 550 | +50 μm |

Step 11: “Begin grinding”

Pressure level p3, p4 at inlet 22 and outlet 23 of first turbo-engine 11 is increased. The rotor assembly moves in the direction of second turbo-engine 17. A coating on the contoured surface of the engine housing of second turbo-engine 17 is ground.

| p1 [mbar] | p2 [mbar] | p3 [mbar] | p4 [mbar] | Axial position |
|---|---|---|---|---|
| 990 | 1,050 | 850 | 750 | 0 μm |

Step 12: “Set contoured gap”

Pressure level p3, p4 at inlet 22 and outlet 23 of first turbo-engine 11 is further increased. Set pressure level p3, p4 is higher than the atmospheric pressure. This situation does not occur during normal operation. An axial force F of −3 N acts upon shaft 13. The rotor assembly moves farther in the direction of second turbo-engine 17. The contoured gap is ground on the side of second turbo-engine 17.

| p1 [mbar] | p2 [mbar] | p3 [mbar] | p4 [mbar] | Axial position |
|---|---|---|---|---|
| 990 | 1,050 | 1,250 | 1,150 | −30 μm |

1-14. (canceled)

15. A method for producing a contoured gap between a rotor and a stator of a turbo-engine, a first turbo-engine driving a second turbo-engine via a common shaft, and the shaft being supported by a bearing in a bearing housing, comprising:
forming the contoured gap between a contoured surface of the rotor and a contoured surface of an engine housing associated therewith, by grinding the contoured surfaces against one another, utilizing an axial clearance of the bearing, as a result of a defined axial force.

16. The method as recited in claim 15 wherein, with a premounted rotor, at least the first turbo-engine, whose engine housing is mounted on the rotor of the first turbo-engine in a first mounting direction axial to the shaft, and the rotor is moved due to the contact between its contoured surface and the corresponding contoured surface of the engine housing axially in the mounting direction from a first axial position to a second axial position between the first axial position and an axial limit stop located in the mounting direction.

17. The method as recited in claim 15 wherein, to set a zero gap between the contoured surface of the rotor and the contoured surface of the engine housing,
an overpressure is applied to the first turbo-engine until a preset first axial force acts upon the shaft in the mounting direction, and the contoured surfaces are separated by a gap;
the rotor is accelerated by a pressure difference between an inlet and an outlet of the first turbo-engine; and
the pressure at the inlet and outlet is reduced until the contoured surface of the rotor grinds on the contoured surface of the engine housing with a preset second axial force, and the rotor decelerates.

18. The method as recited in claim 17 wherein the rotor accelerates repeatedly and grindingly decelerates until the axial force has dropped to approximately 0 N.

19. The method as recited in claim 15 wherein, to set the contoured gap, the pressure at the inlet and outlet of the first turbo-engine is evenly reduced, starting at a partial vacuum, and/or an overpressure is set at the second turbo-engine until a preset axial force, acting against the mounting direction upon the shaft, is established.

20. The method as recited in claim 19 wherein the rotor accelerates repeatedly and grindingly decelerates until the axial force has dropped to a preset value above the axial force during normal operation.

21. The method as recited in claim 15 wherein, when the engine housing of the first turbo-engine is in the mounted state and the rotor of the second turbo-engine is in the premounted state, the engine housing of the second turbo-engine is mounted on the rotor of the second turbo-engine in a second mounting direction opposite to the first mounting direction axial to the shaft, and the rotor is moved by the contact between its contoured surface and a corresponding contoured surface of the engine housing axially in the second mounting direction from a third axial position to a fourth axial position between the third axial position and an axial limit stop located in the second mounting direction.

22. The method as recited in claim 15 wherein, to set a zero gap for the second turbo-engine, the rotor is repeatedly accelerated and grindingly decelerated until the axial force has dropped to approximately 0 N and the rotor has moved from the axial limit stop to an axial zero position.

23. The method as recited in claim 15 wherein, to set a contoured gap for the second turbo-engine, the rotor is repeatedly accelerated and grindingly decelerated until the axial force has reached a preset value and the rotor has moved from the axial limit stop to an axial operating position.

24. A turbo-engine, comprising:
a rotor and an engine housing associated with the rotor, and having a contoured gap between a contoured surface of the rotor and a contoured surface of the engine housing,
wherein the contoured gap is settable by grinding the contoured surfaces of the rotor and engine housing, utilizing an axial clearance of the bearing, as a result of a defined axial force.

25. The turbo-engine as recited in claim 24 wherein the contoured surfaces have a grindable material pairing.

26. The turbo-engine as recited in claim 24 wherein at least one of the contoured surfaces of the rotor and engine housing has a texture which favors grinding.

27. The turbo-engine as recited in one of claim 24 wherein at least one of the contoured surfaces of the rotor and engine housing is coated.

28. The turbo-engine as recited in claim 27 wherein the coating includes polytetrafluoroethylene.

29. The turbo-engine as recited in claim 24, wherein the turbo-engine is a turbocharger.

30. The turbo-engine as recited in claim 29, wherein the turbo-charger is a secondary air charger and/or an exhaust gas turbocharger for an internal combustion engine of a motor vehicle.
